(19) United States
(12) Patent Application Publication
(10) Pub. No.: US 2023/0335959 A1
(43) Pub. Date: Oct. 19, 2023

(54) TURNABLE ELECTRICAL CONNECTOR AND CABLE ASSEMBLY

(71) Applicant: ITT Manufacturing Enterprises, LLC, Wilmington, DE (US)

(72) Inventors: Bernd Hagmann, Bad Überkingen (DE); Sebastian Richter, Schorndorf (DE)

(21) Appl. No.: 17/723,759

(22) Filed: Apr. 19, 2022

(51) Int. Cl. H01R 24/58; H01R 13/24

(52) U.S. Cl. CPC H01R 24/58; H01R 13/2421; H01R 2105/00

(57) ABSTRACT

An electrical cable connector, assembly, system, and/or method is disclosed that includes a pin side connector comprising a plurality of conductor members and one or more insulator members alternating along a longitudinal axis, each of the plurality of conductor members having a base and a stem extending from the base and configured to electrically connect to one or more wires; and a socket connector comprising a plurality of conductive elements and one or more insulative elements arranged along the longitudinal axis, wherein each of the plurality of conductive elements has a center channel and each of the one or more insulative elements has a through-hole, wherein the center channels of each of the plurality of conductive elements and the through-holes of each of the one or more insulative elements are aligned and configured to form a receptacle in communication with an end opening, wherein the pin side connector is received in and freely rotatable with respect to the receptacle of the socket connector.

### BACKGROUND

The present application relates generally to electrical cable connectors and assemblies, preferably for connecting an electrical cable or cord providing electrical power and signals to another electrical cable, cord, socket, and/or receptacle.

### SUMMARY

The summary of the disclosure is given to aid understanding of electrical cable connectors and assemblies, including electrical cable connectors and assemblies that are configured so that one end of the cable connector or assembly is rotatable or turnable with respect to the other end of the cable connector or assembly, and not with an intent to limit the disclosure or the invention. The present disclosure is directed to a person of ordinary skill in the art. It should be understood that various aspects and features of the disclosure may advantageously be used separately in some instances, or in combination with other aspects and features of the disclosure in other instances. Accordingly, variations and modifications may be made to the electrical cable connector or assembly and/or methods for connecting electrical cables to achieve different effects.

An electrical cable connector, assembly, product, and/or technique according to one or more embodiments for connecting an electrical cable to another electrical cable, cord, socket, and/or receptacle is disclosed. In one or more approaches one connector, assembly, and/or product (e.g., a pin connector) is rotatable or turnable with respect to the other connector, assembly, and/or product (e.g., a socket connecter). In one or more arrangements, a pin side connector for electrically connecting to an electrical socket connector is disclosed, the pin side connector including: a plurality of conductor members, each of the plurality of conductor members having a longitudinal axis, a base, and a stem extending from the base along the longitudinal axis of the conductor member, the base having an exterior surface that is substantially circumferentially shaped and the stem configured to electrically connect to one or more conductive wires; and one or more insulator members configured to electrically insulate the plurality of conductor members, at least one of the insulator members having a longitudinal axis, a base portion, and a stem portion extending from the base along the longitudinal axis of the at least one insulator member. In an approach, the longitudinal axis of each of the plurality of conductor members and the longitudinal axis of each of the one or more insulator members of the pin side connector is aligned and coincident with a longitudinal axis of the pin side connector.

In an embodiment of the pin side connector, each base of the plurality of conductor members is spaced along the longitudinal axis of the pin side connector and the base portion of the at least one of the one or more insulator members is spaced along the longitudinal axis of the pin side connector, wherein each base of the plurality of conductor members is spaced from and electrically insulated from an adjacent base by the base portion of the at least one of the one or more insulator members. In a further aspect of the pin side connector, each stem of the plurality of conductor members is aligned with and extends in the direction of the longitudinal axis of the pin side connector and the stem portion of the at least one of the one or more insulator members is aligned with and extends in the direction of the longitudinal axis of the pin side connector, wherein the stem portion of the at least one of the one or more insulator members is nested between the stems of adjacent conductor members and electrically insulates the two adjacent conductor members. The pin side connector in an arrangement is configured to be rotatable with respect to the socket connector and preferably rotatable about the longitudinal axis of the pin side connector relative to the socket connector.

A socket connector for electrically connecting to a pin side connector is disclosed, the socket connector according to a configuration includes: a plurality of conductive elements, each conductive element having a center channel aligned along a longitudinal axis of the conductive element; one or more insulative elements, each insulative element having a through-hole aligned along a longitudinal axis of the insulative element; and a housing having a longitudinal axis and an end opening for receiving the pin side connector, the housing retaining the plurality of conductive elements and the one or more insulative elements. According to an arrangement of the socket connector, each of the plurality of conductive elements is arranged so that its center channel is aligned with the longitudinal axis of the housing and each of the one or more insulative elements is arranged so it’s through-hole is aligned with the longitudinal axis of the housing. In a further embodiment of the socket connector, the one or more insulative elements are arranged and configured in alternating relationship between the plurality of conductive elements to electrically insulate the plurality of conductive elements.

The center channels of each of the plurality of conductive elements and the through-holes of the one or more insulative elements in an aspect of the socket connector are aligned and configured to form a receptacle in communication with the end opening, and in a further aspect the end opening and the receptacle are configured and shaped to receive the pin side connector. The socket connector in an arrangement is configured to permit rotation of the pin side connector, and according to an embodiment of the socket connector, the socket connector is configured to permit the pin side connector to be rotatable with respect to the receptacle, preferably rotatable about a longitudinal axis of the socket connector and/or receptacle.

An electrical connector assembly is also disclosed, the electrical connector according to an embodiment including: a pin side connector comprising a longitudinal axis, a plurality of conductor members and one or more insulator members configured to electrically insulate the plurality of conductor members, each of the plurality of conductor members having a base and a stem extending from the base and configured to electrically connect to one or more wires, and a socket connector comprising a longitudinal axis, a plurality of conductive elements, one or more insulative elements, and an end opening, wherein each of the plurality of conductive elements is arranged along the longitudinal axis of the socket connector and has a center channel, and wherein each of the one or more insulative elements is arranged along the longitudinal axis of the socket connector and has a through-hole. In an arrangement of the electrical connector assembly, each base of the plurality of conductor members has a circumferential exterior surface aligned along the longitudinal axis of the pin side connector and each of the one or more insulator members has a base aligned along the longitudinal axis of the pin side connector and configured to alternate between each of the plurality of conductor members and electrically insulate each of the bases of the plurality of conductor members.

In an approach of the electrical assembly connector, the center channels of each of the plurality of conductive elements and the through-holes of each of the one or more insulative elements of the socket connector are aligned and configured to form a receptacle in communication with the end opening. The end opening and the receptacle in an aspect of the electrical connector assembly are configured and shaped to receive the pin side connector. The one or more insulative elements of the socket connector in an embodiment are arranged and configured in alternating relationship between the plurality of conductive elements to electrically insulate the plurality of conductive elements. In response to the pin side connector being received within the receptacle of the socket connector, the plurality of conductor members in an embodiment of the electrical connector assembly are in electrical contact with the plurality of conductive elements, and the pin side connector is freely rotatable with respect to, and/or within, the receptacle of the socket connector.

The foregoing and other objects, features and advantages of the invention will be apparent from the following more particular descriptions of exemplary embodiments of the invention as illustrated in the accompanying drawings.

### BRIEF DESCRIPTION OF THE DRAWINGS

The various aspects, features, and embodiments of the methods, techniques, products, assemblies, and/or systems for connecting electrical cables, including cables that provide electrical power, electrical signals, and/or both, to an electrical socket, receptacle, cord, and/or cable will be better understood when read in conjunction with the figures provided. It may be noted that a numbered element in the figures is typically numbered according to the figure in which the element is introduced, is typically referred to by that number throughout succeeding figures, and that like reference numbers generally represent like parts of exemplary embodiments of the invention.

Embodiments are provided in the figures for the purpose of illustrating aspects, features, and/or various embodiments of the methods, techniques, products, assemblies, and/or systems for connecting a first end of an electrical cable to a second end of a different cable, cord, socket, and/or receptacle, but the claims should not be limited to the precise arrangement, configuration, structures, features, aspects, assemblies, subassemblies, systems, embodiments, approaches, methods, processes, or devices shown. The arrangements, configuration, structures, features, aspects, assemblies, subassemblies, systems, embodiments, approaches, methods, processes, and/or devices shown may be used singularly or in combination with other arrangements, configurations, structures, features, aspects, assemblies, subassemblies, systems, embodiments, approaches, methods, processes, and/or devices.

FIG. 1 is a side perspective view of a cable connector assembly having a pin side connector and a socket connector according to an embodiment of the present disclosure.

FIG. 2 is a side perspective view of the pin side connector of the cable connector assembly according to an embodiment of the present invention.

FIG. 3 is a side cross sectional view of the pin side connector of the cable connector assembly, according to an embodiment of the present disclosure.

FIG. 4 is a side cross sectional view of the pin side connector of the cable connector assembly, according to another embodiment of the present disclosure.

FIG. 5 is a side perspective view of an example conductor member of a pin side connector of a cable connector, according to an embodiment of the present disclosure.

FIG. 6 is a side perspective view of an example insulator member of a pin side connector of a cable connector, according to an embodiment of the present disclosure.

FIG. 7 is an exploded perspective view of the socket connector of the cable connector assembly according to an embodiment of the present disclosure.

FIG. 8 is a side perspective view of the socket connector of a cable connector assembly according to an embodiment of the present disclosure.

FIG. 9 is a side perspective view of the socket connector of a busbar connector assembly according to an embodiment of the present disclosure.

FIG. 10 is a side perspective view of a conductive element of a socket connector according to an embodiment of the present disclosure.

FIG. 11 is a side perspective view of an insulative element of a socket connector according to an embodiment of the present disclosure.

FIG. 12 is side view of the pin side connector and a cross-sectional view of the socket connect of the cable connector assembly, according to an embodiment of the present invention, wherein the pin side connector is inserted into and electrically connected to the socket connector.

FIG. 13 is a cross section view of a coaxial cable used to connect to the pin side connector of the cable connector assembly, according to an embodiment of the present disclosure.

FIG. 14 is a side perspective view of a coaxial cable in an example process of being connected to a pin side connector of the cable connector assembly, according to an embodiment of the present disclosure.

FIG. 15 is a side elevation view of a coaxial cable in the example process of FIG. 14 where pin side connector of the cable connector assembly is being connected to a coaxial cable, according to an embodiment of the present disclosure.

FIG. 16 is a side perspective view of a coaxial cable in the example process of FIG. 14 being connected to a pin side connector of the cable connector assembly, according to an embodiment of the present disclosure.

FIG. 17 is a side perspective view of a coaxial cable in an example process of FIG. 14 being connected to a pin side connector of the cable connector assembly, according to an embodiment of the present invention.

FIG. 18 is a side perspective view of a non-coaxial cable in an example process of being connected to a pin side connector of the cable connector assembly, according to an embodiment of the present disclosure.

FIG. 19 shows a side perspective view of a non-coaxial cable in an example process of FIG. 18 where power lines are connected to a pin side connector of the cable connector assembly, according to an embodiment of the present disclosure.

FIG. 20 shows a cable containing two pins side connectors according to an embodiment of the present disclosure, used in an example application with a socket connector inside the electric vehicle charging connector and a second socket connector at the electric vehicle charging station.

### DETAILED DESCRIPTION

The following description is made for illustrating the general principles of the invention and is not meant to limit the inventive concepts claimed herein. In the following detailed description, numerous details are set forth in order to provide an understanding of methods, techniques, electrical connector products, electrical connector assemblies, and/or electrical connector systems for connecting an electrical cable or cord to an electrical socket, receptacle, and/or other cable for providing electrical power and/or signals to the socket, receptacle, and/or the another cable, however, it will be understood by those skilled in the art that different and numerous embodiments of the methods, techniques, products, connectors, assemblies, and/or systems may be practiced without those specific details, and the claims and disclosure should not be limited to the arrangements, configuration, embodiments, features, aspects, assemblies, subassemblies, structures, processes, methods, or details specifically described and shown herein. In addition,features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It should also be noted that, as used in the specification and the appended claims, the singular forms “a”, “an” and “the” include plural referents unless otherwise specified, and that the terms “includes”, “including”, “comprises”, and/ or “comprising,” when used in this specification, specify the presence of stated features, integers, steps, operations, elements, and/or components, but do not preclude the presence or addition of one or more other features, integers, steps, operations, elements, components, and/or groups thereof.

The following discussion omits or only briefly describes electrical cables for delivering power and signals including coaxial cable, which are apparent to those skilled in the art. It is assumed that those skilled in the art are familiar with electrical cables for delivering power and signals, including appropriate dimensions, configurations and materials for electrical conductors for carrying various amounts of power (e.g., current and/or voltage levels), as well as dimensions, configurations, and materials for electrically insulating and/or isolating the electrical conductors carrying the various amounts of power (e.g., current and/or voltage levels).

Disclosed is an electrical cable connector, assembly, system, and/or process for connecting a cable or cord to another cable, cord, receptacle, and/or socket, for example to provide power and/or electrical signals (e.g., voltage levels) to the other cable, cord, receptacle, and/or socket. The electrical connector and cable assembly can take on numerous different styles and contain various numbers of electrical power conductors and signal conductors. The electrical connector assembly preferably permits 360 degrees of rotation without any angle limitation, including 360 degrees of rotation of a pin side connector within a socket connector. The electrical connector and cable assembly preferably can carry high electrical currents of up to 500 amps and up to 1500 volts, although other current ranges and voltages are contemplated, including both higher and lower current and voltage levels.

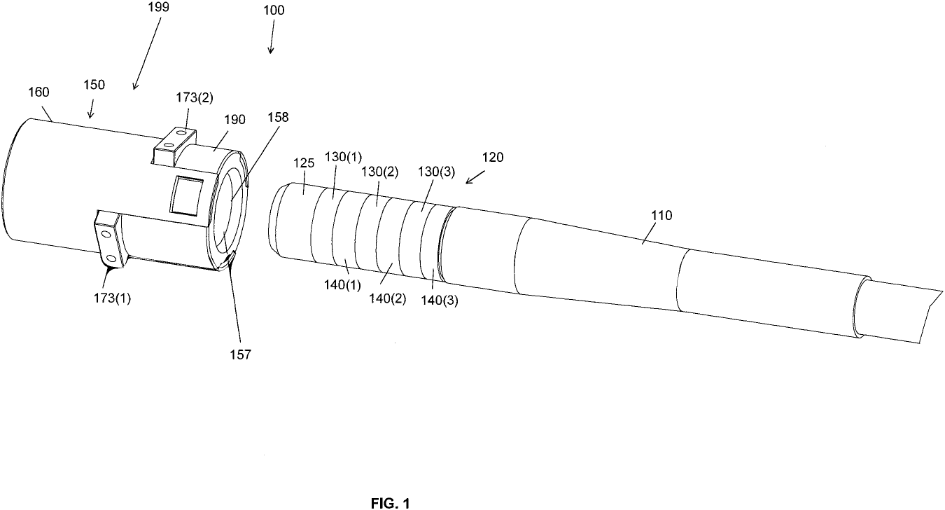

FIG. 1 illustrates an electrical connector assembly 100 according to an embodiment of the present disclosure having a pin side connector 120 and a socket connector 150. Cable 110 containing power conductors and signals conductors is attached to pin side connector 120. The pin side connector 120 of FIG. 1 has three (3) conductor members 130 to handle and or connect to three (3) power lines at different voltage potentials, however, pin side connector 120 can contain more or less conductor members 130 to handle more or less power lines. The pin side connector 120 in the embodiment of FIG. 1 also contains end cap 125. End cap 125 can optionally contain signal contact cap 126 to connect to the signal conductors in the cable 110, and the number of signal conductors can vary depending upon the application.

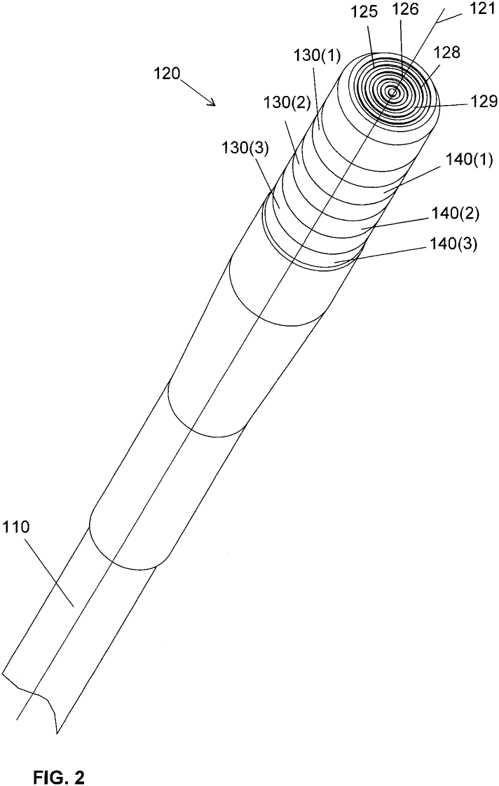

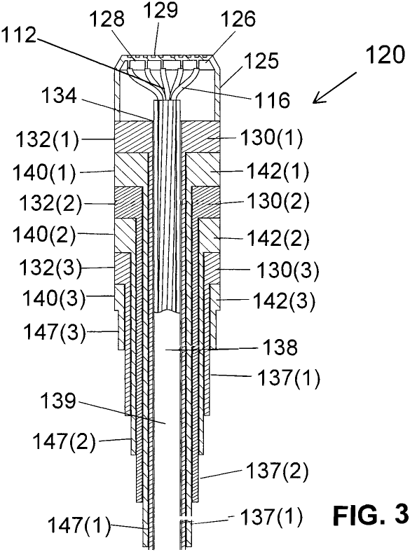

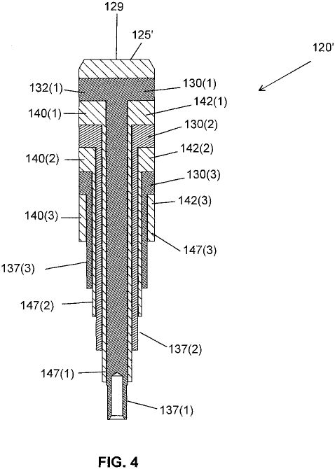

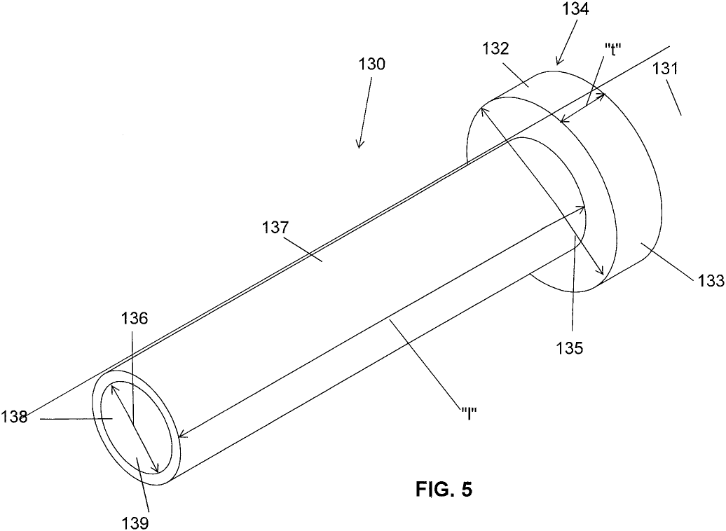

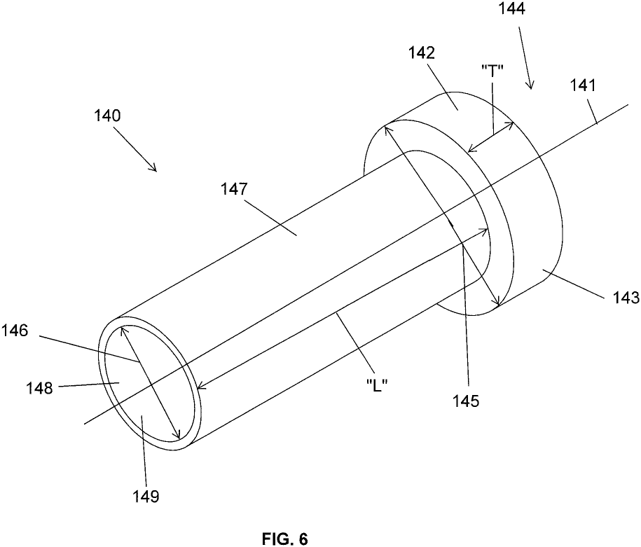

FIG. 2 shows a side perspective view of an embodiment of pin side connector 120 connected to cable 110. FIG. 3 shows a cross sectional side view of the pin side connector 120 of FIG. 2 while FIG. 4 shows a cross sectional side view of an alternative embodiment of pin side connector 120′. As shown in FIGS. 2 - 4, pin side connector 120 includes multiple conductor members 130 and one or more insulator members 140 electrically insulating and/or isolating the conductor members 130. In the embodiment of FIGS. 2 - 4 there are three (3) conductor members 130 and three (3) insulator members 140, although more or less conductor members 130 and insulator members 140 are contemplated, and will in part depend upon the number of power lines in the cable 110 and/or the application to which the electrical connector assembly is directed. FIG. 5 shows a perspective view of a representative conductor member 130 while FIG. 6 shows a perspective view of a representative insulator member 140.

More specifically, as shown in FIGS. 3-6, each conductor member 130 has a base 132 and a stem 137 extending from the base 132 along a longitudinal axis 131 of the conductor member 130. The base 132 preferable is configured as a ring or hollow disc having an exterior surface 133 and an axial bore 134 extending along the longitudinal axis 131. The exterior surface 133 of base 132 preferably is at least partially circumferential and/or cylindrical in shape as shown, and is defined by an outer diameter 135. Other shapes and configurations for the exterior surface 133 of the base 132 of the conductor member 130 are contemplated. For example, the exterior or outer surface 133 could contain grooves or relief portions (not shown).

The stem 137 extends from base 132 a distance or length “l”. The stem 137 preferably is configured as a hollow tube that extends from base 132 and has a center channel 138. Other shapes and configurations are contemplated for stem 137 of the conductor member 130. The center channel 138 of the stem 137 communicates and aligns with the axial bore 134 of the base 132 to form central channel 139 extending along the length of the conductor member 130. The stem portion 137 and the central channel 139 (defined by inner diameter 136) of each conductor member 130 in an arrangement has a different inner and outer diameter as well as a different length.

Each insulator member 140 has a base portion 142 and a stem portion 147 extending from the base portion 142 along a longitudinal axis 141 of the insulator member 140. The base portion 142 preferable is configured as a ring or hollow disc having an exterior surface 143 and an axial bore 144 extending along the longitudinal axis 141. The exterior surface 143 of the base portion 142 preferably is at least partially circumferential and/or cylindrical in shape as shown, and is defined by an outer diameter 145. Other shapes and configurations for the exterior or outer surface 143 of the base portion 142 of the insulator member 140 are contemplated. For example, the exterior or outer surface 143 could contain grooves or relief portions (not shown).

The stem portion 147 extends from base portion 142 a distance or length “L”. The stem portion 147 preferably is configured as a hollow tube that extends from base portion 142 and has a center channel 148. Other shapes and configurations for stem portion 147 of the insulator member 140 are contemplated. The center channel 148 of the stem portion 147 communicates and aligns with the axial bore 144 of the base portion 142 to form central channel 149 extending along the length of the insulator member 140. The stem portion 147 and the central channel 149 (defined by inner diameter 146) of each insulator member 140 in an arrangement has a different inner diameter and outer diameter as well as a different length.

In an arrangement, the longitudinal axis 131 of each of the plurality of conductor members 130 and the longitudinal axis 141 of the one or more insulator members 140 are aligned with, and preferably coincident with, the longitudinal axis 121 of the pin side connector 120. The bases 132 of the conductor members 130 and the base portions 142 of the insulator members 140 in an arrangement are aligned axially along the longitudinal axis 121 of the pin side connector 120, and in an approach the bases 142 of the insulator members separate and electrically insulate the bases 132 of the conductor members 130 along the longitudinal axis 121 of the pin side connector 120.

The stem 137 of the conductor members 130 and the stem portions 147 of the insulator members 140 in a preferred embodiment fit concentrically like nesting dolls as shown in FIGS. 3 & 4, where the stems 137 of the conductor members 130 and the stem portions 144 of the insulator members 140 alternate along a cross section of the socket connector so that the conductor members 130 are electrically insulated from each other. In an embodiment, the conductor members 130 are rotatably fixed to the cable 110 (e.g., to the power conductors) and in an aspect rotate with the cable 110, and in a further embodiment the conductor members 130 are rotatably fixed to the insulator members 140. In an approach, the conductor members 130 rotate with, preferably in unison with, the insulator members 140 and/or the cable 110.

The outer or exterior surface 133 of at least a portion of each conductor member 130 and the outer or exterior surface 143 of at least a portion of each insulator member 140 is preferably circular or cylindrically shaped as shown in FIGS. 2- 6 to permit and/or facilitate rotation of the pin side connector 120 within the socket connector 150. Other shapes are contemplated for the outer surface 133 of each conductor member and the outer surface 143 of each insulator member which can also permit and/or facilitate rotation of the pin side connector within socket connector 150, more specifically within the receptacle of the socket connector 150. The conductor members 130 and insulator members 140 are configured, sized, and arranged to handle the power (e.g., the current and voltage) associated with the particular application in which the electrical connector assembly 100 is associated. In an embodiment, conductive members 130 are formed of pure copper or copper alloys (like brass, copper-nickel, copper-tellurium or bronze) and insulator members 140 are formed of thermoplastic materials for technical applications with properties to ensure electrical insulation (e.g., nylon). The insulator members 140 are configured of a material and sized and dimensioned to electrically insulate the conductor members 130, and that configuration generally will vary depending on the power, e.g., the current and voltage, being carried by the conductor members 130.

In an embodiment, each base 132 of a representative conductor member 130 has an outer diameter 135 of about 20 mm to about 100 mm, more preferably about 30 mm, and a height or thickness (t) of about 5 mm to about 20 mm, more preferably about 12 mm. Both sizes depend on the exact level of power transition. A lower specified current level permits a smaller size of the connector. Preferably the outer diameter 135 of each base 132 is the same and the thickness or height (t) of each base 132 is the same. Other outer diameter 135 and height (or thickness (t)) dimensions are contemplated for base 132. In an embodiment, each base portion 142 of a representative insulator member 140 has an outer diameter 145 equal to the diameter of the conductive elements, and a height or thickness (T) of about 2 mm to about 20 mm, more preferably about 15 mm. The thickness depends on the specified voltage level to ensure a sufficient electrical distance and can be decreased for a lower voltage level. In an embodiment, the outer diameter 145 of each base 142 is the same and the thickness or height (T) of each base 142 is the same. Other outer diameter 145 and height (or thickness (T)) dimensions are contemplated for base 142. In an embodiment, the outer diameters 135 of each of the bases 132 of the conductive members 130 are the same as the outer diameters 145 of each of the base portions 142 of the insulator members 140. It is contemplated that the outer diameter 135 of one or more of the bases 132 of the conductor members 130 can be different than the outer diameter 145 of one or more of the base portions 142 of the insulator members 142.

As shown in FIGS. 3 & 4, in an embodiment, the stem 137(1) of the inner most (first) conductive member 130(1) has the longest length “l” and the smallest (outer and inner) diameter of the conductor members 130, while the stem 137(3) of outer most (third) conductor member 130(3) has the shortest length “l” and the largest (inner and outer) diameter of the conductor members 130. Similarly, the stem portion 147(1) of the inner most (first) insulator member 140(1) has the longest length “L” and the smallest (inner and outer) diameter of the insulator members 140, while the stem 147(3) of the outer most (third) insulator member 140(3) has the shortest length “L” and the largest (inner and outer) diameter of the insulator members 140. It can be seen in FIG. 4, that in an embodiment, the outermost insulator member 140(3) can be effectively formed as only a base 142, e.g., a ring or hollow disc with little to no stem portion 147.

Pin side connector 120 in an embodiment has an end cap 125. The end cap 125 can have an outer diameter that is the same as or smaller than the outer diameter 135 of the base 132 of the conductor member 130 and/or the outer diameter 145 of the base portion 142 of the insulator member 140. The end cap 125 can be formed with a beveled or rounded leading edge to facilitate insertion into socket connector 150. The end cap 125 can be formed of different materials than the conductor members 130 and/or the insulator members 140, and is preferably electrically insulated from any adjacent conductor member 130.

The end cap 125 in an approach is in contact with and in a further aspect rotatably fixed to its adjacent conductor member 130 (e.g., first conductor member 130(1)) such that the end cap 125 rotates with, preferably rotates in unison with, conductor members 130, preferably also with insulator members 140. In a further embodiment, end cap 125 is rotatably fixed to cable 110 such that the end cap 125 rotates with, preferably rotates in unison with, cable 110, and in a further approach also is rotatably fixed to the conductor members 130. In an arrangement, the end cap 125, the conductor members 130, and/or the insulator members 140 can be configured and shaped to have corresponding keyed surfaces and/or shapes such that rotation of one of the components rotates one or more of its adjacent components.

End cap 125 can be configured in a number of different arrangements. In an embodiment as shown in FIG. 3, end cap 125 can contain a signal contact cap 126. The signal contact cap 126 is at the end of the end cap 125 and connects lines or wires 116 carrying signal currents (generally less than 2 amps) in the cable 110 to circumferential contacts 128 on the exterior or distal end 129 of the pin side connector 120. The circumferential contacts 128 in an approach are configured as conductive, concentric rings that are electrically isolated or insulated from each other. The signal contact cap 126, or the end cap 125, in an embodiment can be configured as a slip ring or pancake slip ring connector, (http://www.rotarx.com/en/slip-rings/pancake-slip-rings/), available for example, from RotarX. Still other rotatable signal connectors are contemplated for signal contact cap 126, or the end cap 125.

In an embodiment as shown in FIG. 4, for example, where no signal lines are associated with the application (e.g., where cable 110 does not contain any active signal lines), the pin side connector 120′ has an end cap 125′ that contains no signal connections. The end cap 125′ can be formed of, for example, an insulating material, but other materials are contemplated for end cap 125′. End cap 125′ is preferably electrically insulated from any adjacent conductor member 130. In the embodiment of FIG. 4, where no signal connections are present in end cap 125′, the inner most conductor member 130(1) can be formed with a solid base 132 and a solid stem 137 such than the inner most conductor member 130(1) does not have a central channel 139.

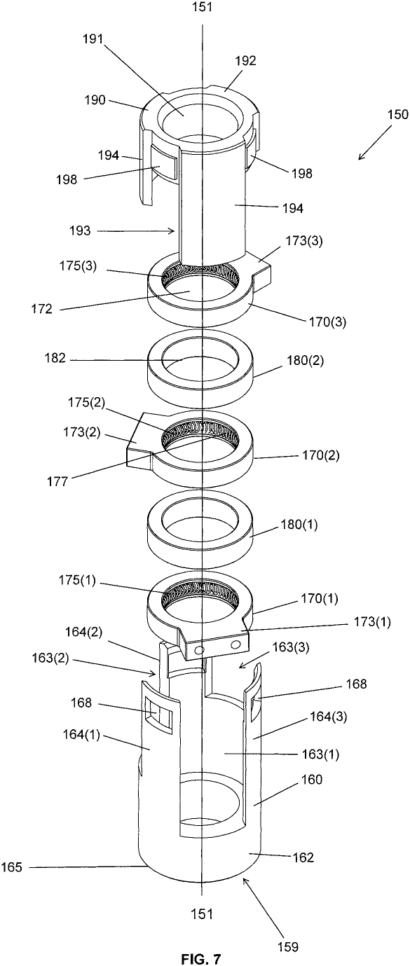

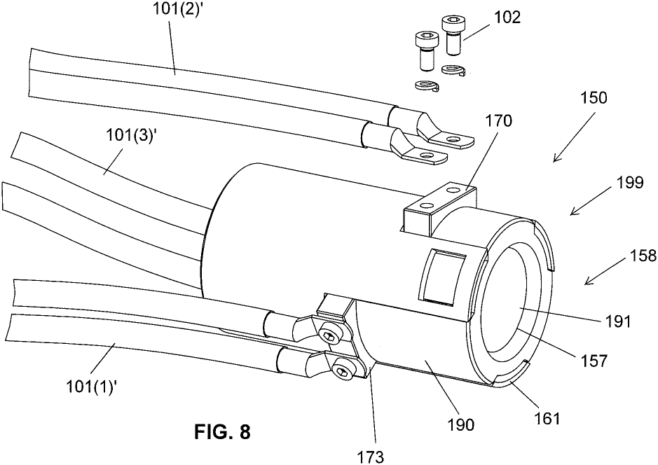

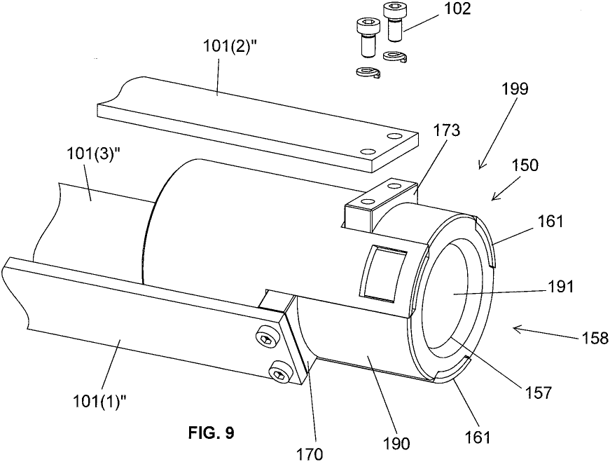

FIG. 7 illustrates an exploded view of socket connector 150, according to an embodiment of the present disclosure, configured for mating with and/or electrically connecting with pin side connector 120. FIGS. 8 & 9 show a perspective view of socket connector 150 according to the configuration of FIG. 7 connected to power conductors 101 (e.g., power lines 101′ in FIG. 8 and power bar 101″ in FIG. 9). Screws 106 are used to connect power conductors 101 to socket connector 150, and more specifically for connecting to power conductive elements 170.

Socket connector 150 has a longitudinal axis 151, conductive elements 170, insulative elements 180, and a housing 199 that includes a base portion 160 and a retaining cap 190 as shown in FIG. 7. The conductive elements 170 are aligned along longitudinal axis 151 of the socket connector 150 and separated by insulative elements 180. As shown in FIGS. 7-9, conductive elements 170 and insulative elements 180 are contained within housing 199 along longitudinal axis 151 in alternating relationship. That is, the conductive elements 170 are separated by insulative elements 180 to electrically insulate and/or isolate the conductive elements 170 along the longitudinal axis 151.

An opening 157 (shown in FIGS. 8 & 9) to a receptacle 158 (shown in FIGS. 8 & 9) is formed in socket connector 150 (e.g., housing 199) that is configured to receive the pin side connector 120. More specifically, in an arrangement, an opening 191 is formed in the retaining cap 190 which forms opening 157 in the socket connector 150 and housing 199. The retaining cap 190, the conductive elements 170, and insulative elements 180 are configured to form the receptacle 158 to receive the pin side connector 120.

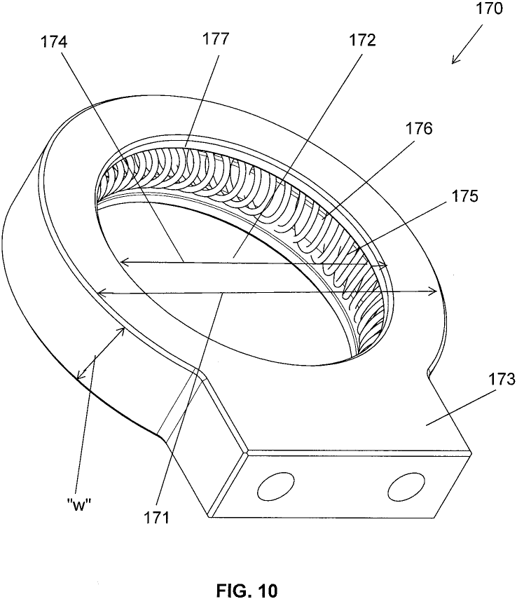

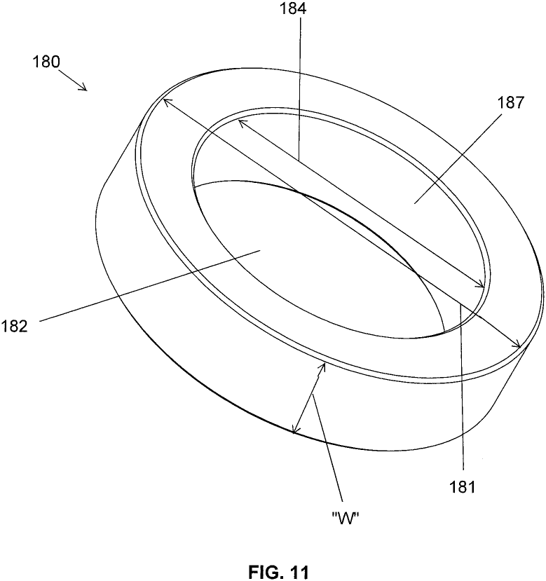

FIG. 10 shows a perspective view of a representative example conductive element 170 while FIG. 11 shows a perspective view of a representative example insulative element 180. Each of the plurality of conductive elements 170 has a center channel 172 extending through and preferably aligned with a longitudinal axis of the conductive element 170. Each of the center channels 172 of the conductive elements 170 form an inner or interior surface 177 that is preferably at least partially circumferentially and/or cylindrically shaped with circular openings and defined by an inner diameter 174, although other shapes for the center channel 172 and inner surface 177 are contemplated. For example, the inner surface 171 of center channel 172 of one or more of conductive elements 170 could have grooves or relief portions (not shown). The conductive elements 170 have a thickness or width “w”. Each of the one or more insulative elements 180 has a through hole 182 extending through and preferably aligned with a longitudinal axis of the insulative element 180. Each of the through holes 182 of the insulative elements 180 form an inner surface 187 that is preferably at least partially circumferentially shaped and/or cylindrically shaped with circular openings and defined by an inner diameter 184, although other shapes for through hole 182 and inner surface 187 are contemplated. For example, the inner surface 181 of through hole 182 of the insulative element 180 could have grooves and/or relief portions (not shown). The insulative elements 180 have a thickness or width “W”. When assembled, the center channels 172 of each of the plurality of conductive elements 170 and the through holes 182 of each of the one or more insulative elements 180 are aligned along the longitudinal axis 151 of the socket connector 150 to form receptacle 158. The center channels 172 of the plurality of conductive elements 152 and the through holes 182 of the one or more insulative elements 180 are sized and configured to receive the pin side connector 120.

In an embodiment, each conductive element 170 has an outer diameter 171 of about 30 mm to about 120 mm, more preferably about 40 mm, a center channel 172 having a diameter 174 of about 20 mm to about 100 mm, more preferably about 30 mm, and a thickness or width “w” of about 2 mm to about 20 mm, more preferably about 15 mm. Preferably the outer diameter 171 of each conductive elements 170, the center channel 172 of each conductive element 170, and the thickness or width “w” of each conductive element 170 are the same. Other dimensions for the outer diameter 171, center channel 172 and width (or thickness) “w” are contemplated for conductive elements 170. It is contemplated that each conductive element 170 can have a different outer diameter 171, a different inner diameter 174, and a different width “w”.

In an embodiment, each insulative element 180 has an outer diameter 181 of about 30 mm to about 120 mm, more preferably about 40 mm, a through hole 182 having a diameter 184 of about 20 mm to about 100 mm, more preferably about 15 mm, and a thickness or width “W” of about 2 mm to about 20 mm, more preferably about 15 mm. Other outer diameter 181, through hole 182, and width (or thickness) “W” dimensions are contemplated for insulative elements 180. It is contemplated that each insulative element 180 can have a different outer diameter 181, a different inner diameter 184, and a different width “W”.

Preferably the outer diameter 181 of each insulative element 180 is the same dimensions as the outer diameter 171 of each conductive element 170, and/or the diameter 174 of the center channel 172 of each conductive element 170 is the same as the diameter 184 of the through hole 182 of each insulative element 180. The outer diameters 171, the center channels 172, thickness or widths “w” of the conductive elements 170 can also be different than the outer diameters 181, through holes 182 and thickness or widths “W” of the insulative elements 180. In an approach, the thickness or width “w” of the conductive elements 170 is typically different than the thickness or width “W” of the insulative elements 180, but the thicknesses or widths “w”, “W” of the conductive elements 170 and insulative elements 180 can also be the same.

Conductive elements 170 preferably contain lug projections 173 for connecting to power conductors 101 or receptacles (not shown). Screws 106 can be used to connect the power conductors 101 to the lug projections. Other means of connecting the power conductors 101 to the lug projections 173 are contemplated.

Socket connector 150 preferably contains contact springs 175, preferably radial springs, associated with conductive elements 170 of the socket connector 150 to facilitate electrical contact between the conductive elements 170 and the conductor members 130 of pin side connector 120. In an arrangement, the conductive elements 170 are formed with a circumferential channel 176 around the inner surface 177 of the center channel 172 to accommodate and retain springs 175. Other means of associating and/or retaining springs 175 with conductive elements 170 are contemplated. While the electrical connector assembly 100 has been shown with the contact springs 175 associated with, and preferably contained within a circumferential channel 176 in the inner surface 177 of, the conductive elements 170, it can be appreciated that the contact springs can be associated with, and in an embodiment contained within a circumferential channel formed in the outer surface 133 of the bases 133 of the conductor members 130. Other means of associating and/or retaining springs 175 with conductor members 130 are contemplated.

Base portion 160 of housing 199 of socket connector 150 in one or more embodiments has one or more legs 164 extending and/or projecting from central portion 162 forming one or more slots 163 in base portion 160. The legs 164 are preferably circumferentially spaced about the periphery of central portion 162 and form one or more slots between the legs 164. In the embodiment of FIGS. 7-9, three (3) legs 164(1), 164(2), 164(3) extend from central portion 162 and form three (3) slots 163(1), 163(2), 163(3). The slots 163 in base portion 160 each preferably have different lengths, and each slot 163 can have the same or varying widths. Base portion 160 receives three (3) conductive elements 170 and two (2) insulative elements 180 to electrically isolate the three (3) conductive elements 170. Lugs 173 are received in one or more of the slots 173 and preferably project or extend beyond the periphery of the housing 199, e.g., base portion 160 and/or the retaining cap 190. It can be appreciated that more or less conductive elements 170, insulative elements 180, legs 164 and slots 163 can be formed and used in base portion 160 of socket connector 150, which will depend in part on the application of the electrical connector assembly 100.

Retaining cap 190 has an end portion 192 having an opening 191 and projecting portions 194 extending from end portion 192 to form gaps 193 between projecting portions 194. The gaps 193 in retaining cap 190 each preferably have different lengths, and each gap 193 can have the same or varying widths. It can be appreciated that each projecting portion 194 is configured and sized to fit within one of the slots 163 formed in the base portion 160 and each of the legs 164 is configured and sized to fit within one of the gaps 193 in the retaining cap 190 to form housing 199. Each projecting portion 194 in retaining cap 190 has a length that is sized to leave a gap when inserted and/or located in slot 163 in base portion 160 to accommodate a respective lug 173 on conductive element 170. The respective legs 164 and projecting portions 194 can be formed with lips and/or ledges (not shown) to facilitate mating and forming a sealed socket connector 150.

The base portion 160 and the retaining cap 190 are preferably made of insulating material such as plastic and/or made of metal coated with an insulating material. The base portion 160 and retaining cap 190 can also be formed of metal, however, insulating material preferably isolates and/or electrically insulates the conductive elements 170 from coming into electrical contact with the base portion 160 and/or retaining cap 190. In an example embodiment, the base portion 160 and retaining cap 190 are formed of thermoplastic material, for example, nylon. The conductive elements 170 and insulative elements 180 are configured, sized, and arranged to handle the power (e.g., the current and voltage) associated with the particular application in which the electrical connector assembly 100 is utilized. In an embodiment, conductive elements 170 are formed of pure copper or copper alloys (like brass, copper-nickel, copper-tellurium or bronze) and insulative elements 180 are formed of thermoplastic materials for technical applications with properties to ensure electrical insulation (e.g., nylon).

In an embodiment, the base portion 160 snap fits to the retaining cap 190 to form housing 199. In the socket connector 150 of FIGS. 7-9, one or more, preferably each, leg 164 in base portion 160 has an opening 168 to receive a projection or knob 198 formed in the end portion 192 of the retaining cap 190 so that one or more legs 164, and accordingly the base portion 164, attaches to the retaining cap 190. The projections or knobs 198 preferably snap fit into the openings 168. Additionally, and/or alternatively, projections or knobs (not shown) can be formed in base portion 160 to snap fit into one or more openings formed in the retaining cap 190. Additionally, or alternatively, one or more of the legs 164, preferably each of the legs 164, has a lip or ledge that fits over the end portion 192 of the retaining cap 190 and retains, couples, and/or attaches the retaining cap 190 to the base portion 160. Other means of attaching the base portion 160 to the retaining cap 190 to form housing 199 are contemplated, such as, for example, crimping, retaining rings, adhesives, etc.

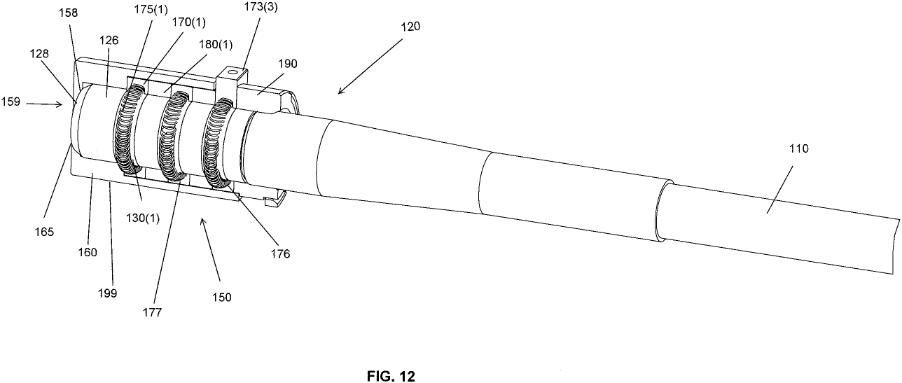

FIG. 12 illustrates electrical connector assembly 100 with pin side connector 120 in mating relationship with a cross-sectional view of socket connector 150. As illustrated in FIG. 12, the pin side connector 120 is configured and dimensioned to be received and fit within the socket connector 150 of the electrical connector assembly 100. That is, in an arrangement, the outer most periphery (e.g., the largest diameter) of each of the end cap 125, the conductor members 130, and/or insulator members 140 is smaller than the smallest of the opening 191 in the retaining cap 190, the center channels 172 of each of the conductive elements 170, and each of the through holes 182 of the insulative elements 180. It can be appreciated that the outer diameter of the pin side connector 120 (e.g., the outer diameter 135 of the conductor members 130 and/or the outer diameter 145 of the insulator members 140) and the inner diameter of the opening 157 and/or receptacle 158 in the socket connector 150 can vary depending upon a number of factors including, for example, the number of power lines, the power being carried by the power lines, and the number of signal lines. In one or more approaches the inner diameter of contact springs 175 is slightly smaller than the inner diameter 174 of the conductive elements 170 and/or the inner diameter 184 of the insulative elements 180. In a further approach the outer diameter 135 of the conductive members 130 and/or the outer diameter 145 of the insulator members 140 is slightly larger than the inner diameter of the contact springs 175.

As illustrated in FIG. 12, when pin side connector 120 is in mating relationship with socket connector 150, first conductor member 130(1) is in electrical contact with first contact spring 175(1), which is in electrical contact with first conductive element 170(1) so that power can be transferred between first conductor member 130(1) of the pin side connector 120 and first conductive element 170(1) of the socket connector 150. Similarly, when pin side connector 120 is in mating relationship with socket connector 150, second conductor member 130(2) is in electrical contact with second contact spring 175(2), which is in electrical contact with second conductive element 170(2) so that power can be transferred between second conductor member 130(2) of the pin side connector 120 and second conductive element 170(2) of the socket connector 150. Further, when pin side connector 120 is in mating relationship with socket connector 150, third conductor member 130(3) is in electrical contact with third contact spring 175(3), which is in electrical contact with third conductor element 170(3) so that power can be transferred between third conductive member 130(3) of the pin side connector 120 and third conductive element 170(3) of the socket connector 150. It can be appreciated that more or less power lines can be incorporated into electrical connector assembly 100 by adding or eliminating respective conductor members 130(x), conductive elements 170(x), insulator members 140(x), and insulative elements 180(x) in the pin side connector 120 and the socket connector 150.

It can be appreciated that the pin side connector 120 can be rotated freely in socket connector 150 about longitudinal axis 151 and is not limited in the angular rotation that pin side connector 120 can rotate or turn within socket connector 150. The conductor members 130 of the pin side connector 120 preferably will make electrical contact with the contact springs 175 and conductive elements 170 throughout the 360 degrees of rotation within the socket connector 150. The circumferential or cylindrical shape of the exterior surface 133 of the conductive members 130 (and in a configuration the circumferential or cylindrical shape of the exterior surface 143 of the insulator member 140) and the circumferential or cylindrical shape of the inner surface 177 of the conductive elements 170 (and in a configuration the circumferential or cylindrical shape of the inner surface 187 of the insulative elements 180 permits and/or facilitates the rotatability of the pin side connector 120 within the socket connector 150, and in an arrangement the electrical contact, preferably continuous electrical contact between the conductor members 150 and the conductive elements 170.

It can be appreciated that contact springs 175 can be optional and pin side connector 120 can be inserted within socket connector 150 and still be rotatable and make electrical contact, preferably continuous electrical contact, between the conductive members 130 and the conductive elements 170. Continuous electrical contact does not necessarily indicate that there is continuous 360 degrees of contact between the conductor members 130 and conductive elements 170 (or contact springs 175), but rather that there is sufficient electrical contact as the pin side connector 120 is rotated within socket connector 150 so that power can be transferred between the conductor members 130 and conductive elements 170.

If pin side connector 120 contains electrical contact cap 126, including, for example, circumferential electrical contacts 128, then socket connector 150 will contain electrical pickup contacts 159 to mate with circumferential electrical contacts 128 when pin side connector 120 is in mating relationship with socket connector 150. Electrical pickup contacts 159 in socket connector 150 can take many forms, including pins (for example spring loaded pins) or circumferential rings. Electrical pickup contacts 159 are configured preferably in the bottom end 165 of the base portion 160 of the socket connector 150. The circumferential electrical contacts 128 of the end cap 125 of the pin side connector 120 preferably make and maintain, and preferably continuously maintain, electrical contact with the electrical pickup contacts 159 of the socket connector 150 as the pin side connector 120 is rotated or turned within the socket connector 150.

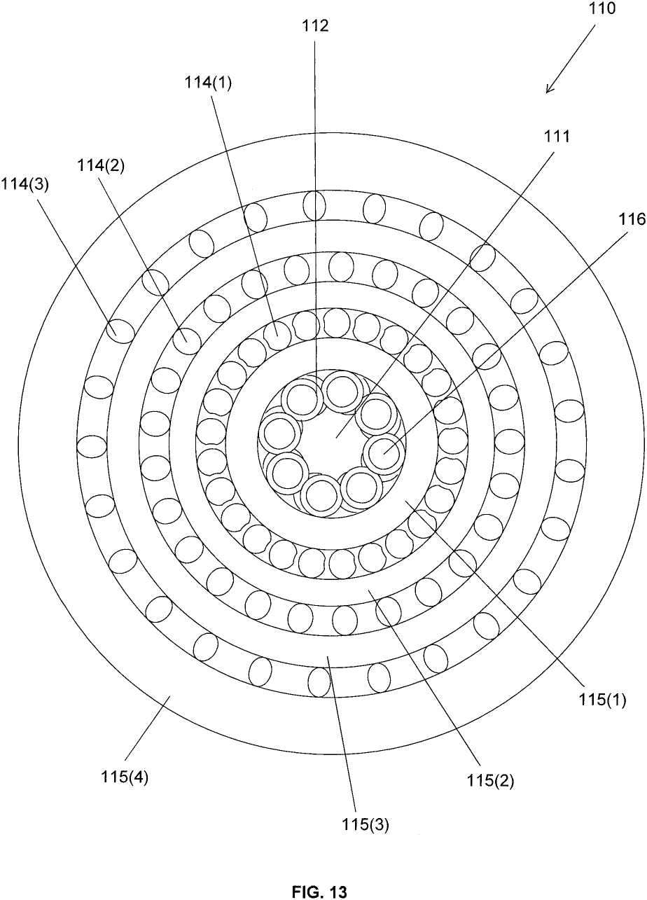

FIG. 13 illustrates a cross section of cable 110. As shown in FIG. 13 cable 110 preferably is a coaxial cable that includes signal wire bundle 112 in the central portion 111 of the cable 110 for transmitting and/or carrying signals, and three (3) power lines/protective earth lines 114 for transmitting carrying power. The three (3) power/earth lines 114 include first set of power lines 114(1), second set of power lines 114(2) and third set of power lines 114(3) where each different set of power/earth lines 114 in coaxial cable 110 contains multiple uninsulated wires that are separated by insulating sheaths 115. The outermost or third set of power line 114(3) is covered by outer sheathing 115(4) while the innermost or first set of power lines 114(1) preferably are insulated from signal wire bundle 112 by sheathing 115(1). The signal wire bundle 112 can contain one or more signal wires 116, where each signal wire is preferably insulated. In the embodiment of FIG. 13, eight (8) signal wires 116 are illustrated, however, more or less signal wires 116 can be contained in central signal wire bundle 116. The insulated sheaths 115 are preferably made of thermoplastic elastomers or rubber, although other materials, configurations, and constructions are contemplated for signal wire bundle 112, power/earth lines 114, insulating sheaths 115, and/or cable 110.

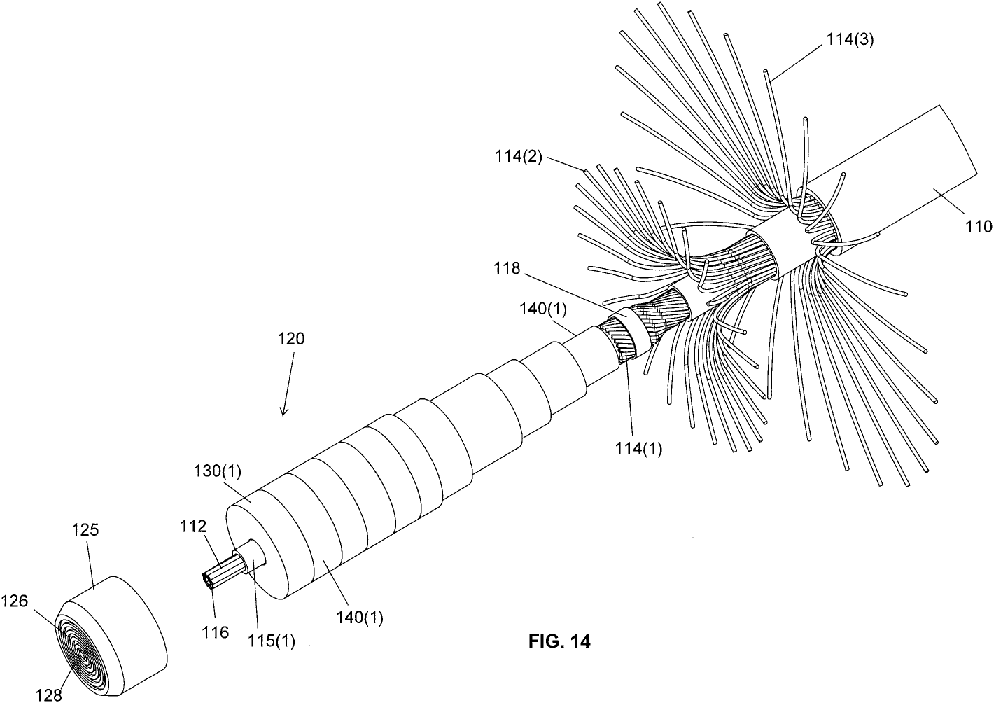

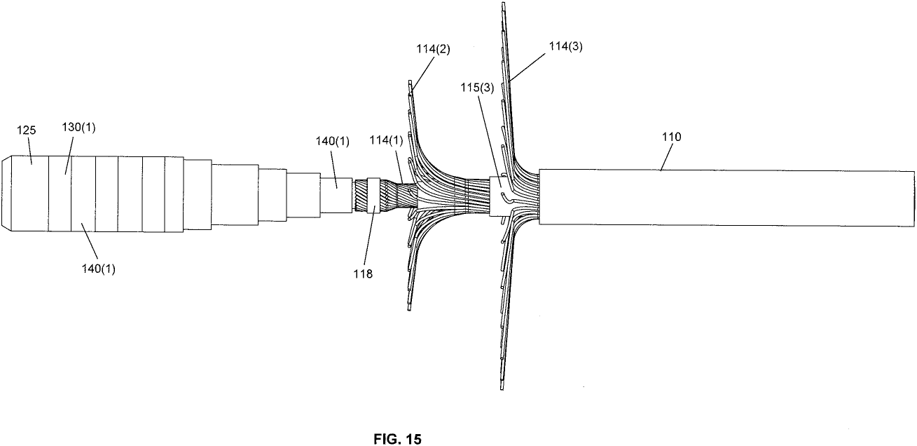

The conductor members 130, insulator members 140 and the end cap 125 of the pin side connector 120 in an embodiment preferably rotate or turn with the cable 110. That is, the conductor members 130, the insulator members 140, and optionally the end cap 125 in an embodiment are rotatably fixed and/or fixedly connected to the cable 110. FIGS. 14- 17 illustrate a process for electrically connecting, preferably rotatably fixedly connecting, coaxial cable 110, including power/earth lines 114 and signal wires 116, to respective conductor members 130 and end cap 125, such that cable 110 does not rotate with respect to the conductor members 130 and/or end cap 125. FIG. 14 illustrates a perspective view of coaxial cable 110 and pin side connector 120 where first power/earth line 114(1) is electrically connected to the stem portion 137(1) of the first conductor member 130(1) by wrapping the power/earth line wires 114(1) around stem portion 137(1) and using a crimp tube 118 to retain and/or fix the power/earth line 114 to the stem portion 137(1) of the first conductor member 130(1). FIG. 14 further illustrates the end cap 125 and cable 110 in the process of being connected together, where end cap 125 is in the process of being electrically connected to signal wire bundle 112. More specifically, each of the signal wires 116 are electrically connected, preferably rotatably fixedly connected, to respective, circumferential contacts 128 of signal contact cap 126 so that the signal wires 116 do not rotate with respect to the signal contact cap 126 (e.g., the signal wires 116 rotate in unison with the signal contact cap 126. Each circumferential (e.g., ring) contact 128 is electrically connected to a different signal wire 116. FIG. 15 illustrates a side view of the pin side connector 120 and coaxial cable 110 being connected together where end cap 125, more specifically the signal contact cap 126, is connected to the signal wire bundle 112 and the first conductor member 130(1) is connected to the first power/earth line 114(1) of the coaxial cable 110 by crimp tube or crimp ring 118.

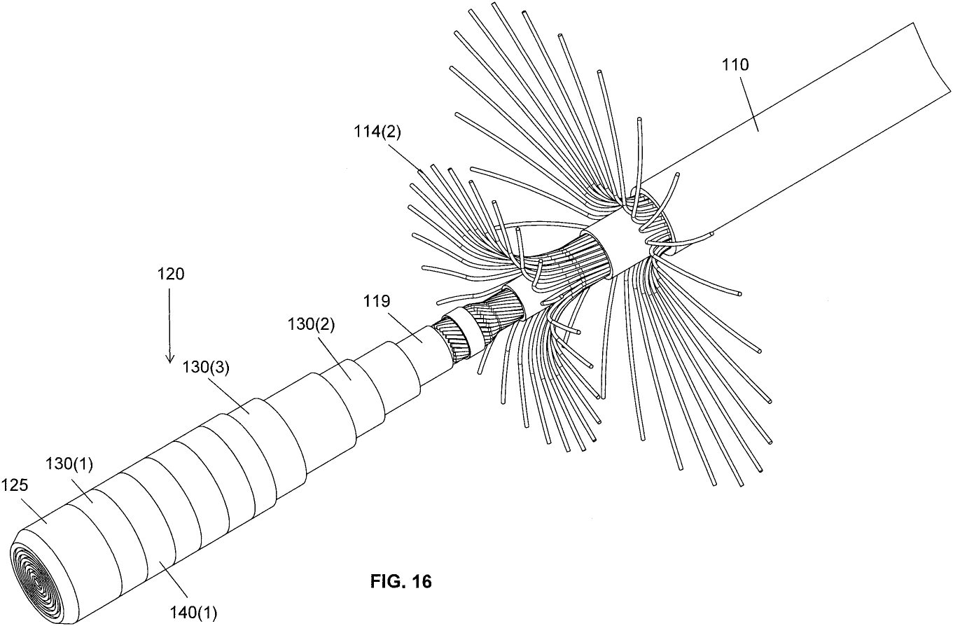

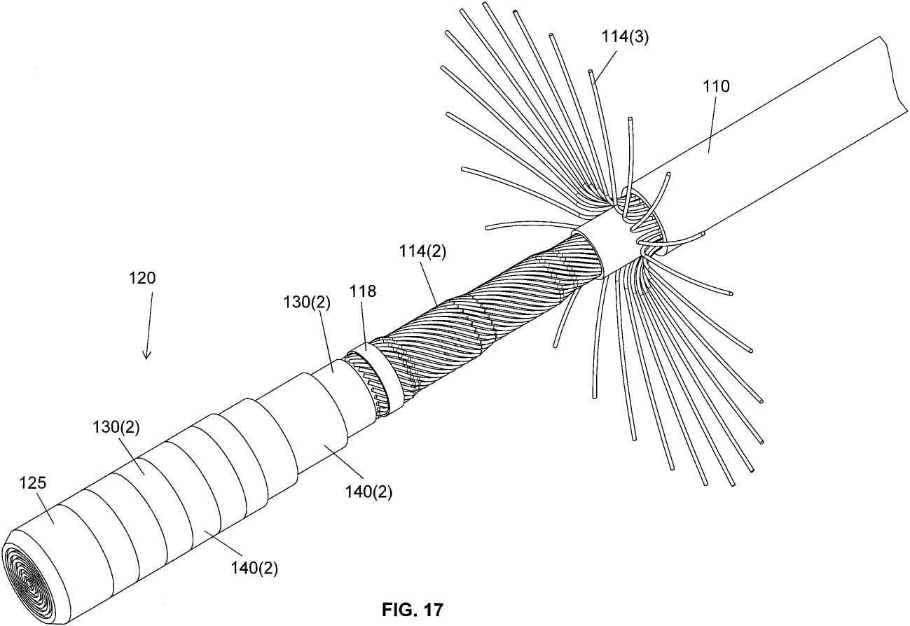

FIG. 16 illustrates a perspective view of coaxial cable 110 and pin side connector 120 where first power/earth line 114(1) is electrically connected to the stem portion 137(1) of the first conductor member 130(1) and an insulating shrink tube or insulating plastic sleeve 119 covers the first power/earth lines 114(1) to provide electrical insulation between the other power/earth lines 114 (e.g., second power/earth line 114(2). Second power/earth lines 114(2) and third power/earth lines 114(3) remain unconnected to respective second conductor members 130(2) and third conductor members 130(3) in FIG. 16. FIG. 17 illustrates a side perspective view of coaxial cable 110 and pin side connector 120 where second power/earth line 114(2) is electrically connected to the stem portion 137(2) of the second conductor member 130(2) by wrapping the power/earth line wires 114(2) around stem portion 137(2) and using a crimp tube 118 to retain and/or fix the second power/earth line 114(2) to the stem portion 134(2) of the second conductor member 130(2). The third power/earth line 114(3) remains unconnected to third conductor member 130(3) in FIG. 17.

Thereafter, an insulating shrink tube or insulating plastic sleeve 119 covers the second power line 114(2) to provide electrical insulation with the other power/earth lines 114 (e.g., first power/earth line 114(1) and third power/earth line 114(3)). Third power/earth line 114(3) is electrically connected to the stem portion 137(3) of the third conductor member 130(3) by wrapping the power/earth line wires 114(3) around stem portion 137(3) and using a crimp tube 118 to retain and/or fix the third power/earth line 114(3) to the stem portion 137(3) of the third conductor member 130(3). In an approach an insulating shrink tube or insulating plastic sleeve 119 covers the third power/earth line 114(3) to provide electrical insulation between the other power/earth lines 114 (e.g., the second power/earth line 114(2)). While the respective power/earth lines 114 have been electrically connected to, rotatably fixedly connected to, and fixedly connected to, the respective conductor members 130 using crimp rings 118, it can be appreciated that other means can be used to electrically and/or fixedly connecting the respective power/earth lines 114 to respective conductor members 130, such as, for example, soldering, welding, crimp sleeves, clamps, adhesive, etc.

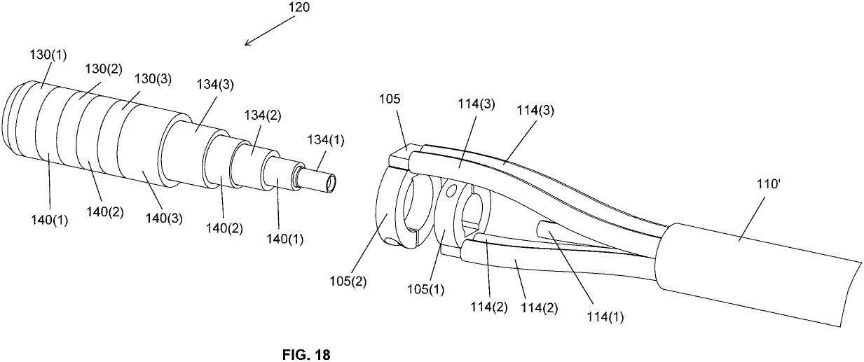

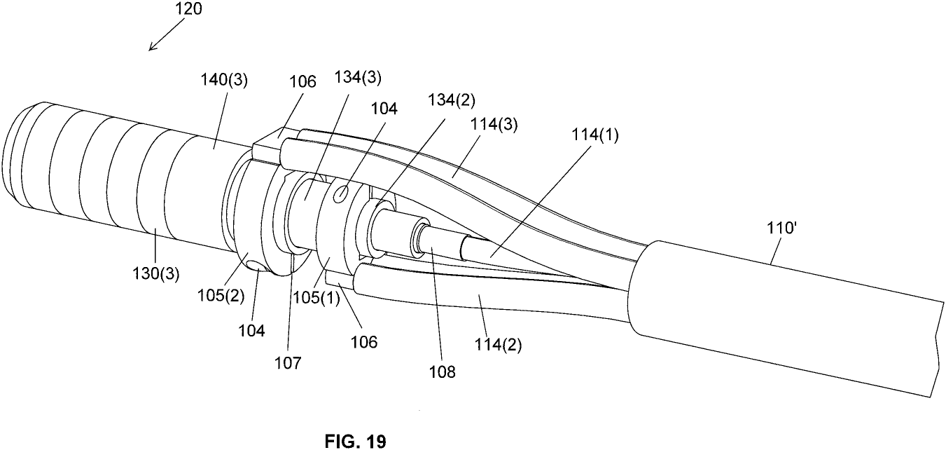

FIGS. 18-19 illustrate an example process for electrically connecting, preferably rotatably fixedly connecting and/or fixed connecting, non-coaxial cable 110′, including power/earth lines 114 (and signal wires 116), to respective conductor members 130 (and end cap 125) in pin side connector 120. As shown in FIGS. 18 & 19, one or more power/earth wires 114(2), in FIGS. 18 and 19 two power/earth wires 114(2), are at the same potential and in one bundle in non-coaxial cable 110′ and electrically (preferably fixedly) connected by first screwable clamp 105(1) to second conductor member 130(2). One or more insulated power/earth lines or wires 114(3), in FIGS. 18 & 19 two power/earth wires 114(3), are at the same potential and in one bundle in non-coaxial cable 110′ and electrically (preferably fixedly) connected by second screwable clamp 105(2) to third conductor member 130(3). Each screwable clamp 105 is configured as a ring or hollow disc that contains a slit 107 and a screw 104 that compresses the screw clamp 105 on the stem portion 137 of the respective conductor member 130. The single wires of the power/earth lines 114 can be attached to the screw clamps 105 with crimping, soldering or clamping, and in and embodiment the screw clamps 105 contain lug portions 106 for electrically connecting, preferably fixedly connecting, the single wires of the power/earth lines 114 to the screw clamps 105.

First power/earth line 114(1) in the embodiment of FIGS. 18 & 19 is connected to the stem portion 137 of first conductor member 130(1) by a tubular crimp 108. Strain relief can be added to the pin side connector 120 as known in the art. The non-coaxial cable 110′ in the embodiment of FIGS. 18 & 19 does not contain a signal wire bundle 112. It can be appreciated that non-coaxial cable 110′ can contain a signal wire bundle 112 containing one or more signal wires 116. It can be appreciated that if a signal wire bundle 112 is included, the signal wire bundle 112 can be connected to end cap 125, more specifically signal wires 116 can be connected to electrical contacts 128 in signal contact cap 126 as explained herein in the embodiment of FIGS. 1-3. In that case where the signal wire bundle 116 is inserted through the pin side connector 120 to the end cap 125, an additional screw clamp 105 could be used to electrically connect, preferably rotatably fixedly connect and/or fixedly connect, the first power/earth line 114(1) to the first conductor member 130(1), or alternative means could be used to electrically connect, preferably rotatably fixedly connect and/or fixedly (and electrically) connect, the first power/earth line 114(1) to the first conductor member 130(1).

It can be appreciated that other means can be utilized to electrically connect, preferably rotatably fixedly connect and/or fixedly (and electrically) connect, the one or more power/earth lines 114 and the one or more signal wires 116 to the respective conductor members 140 in the pin side connector 120.

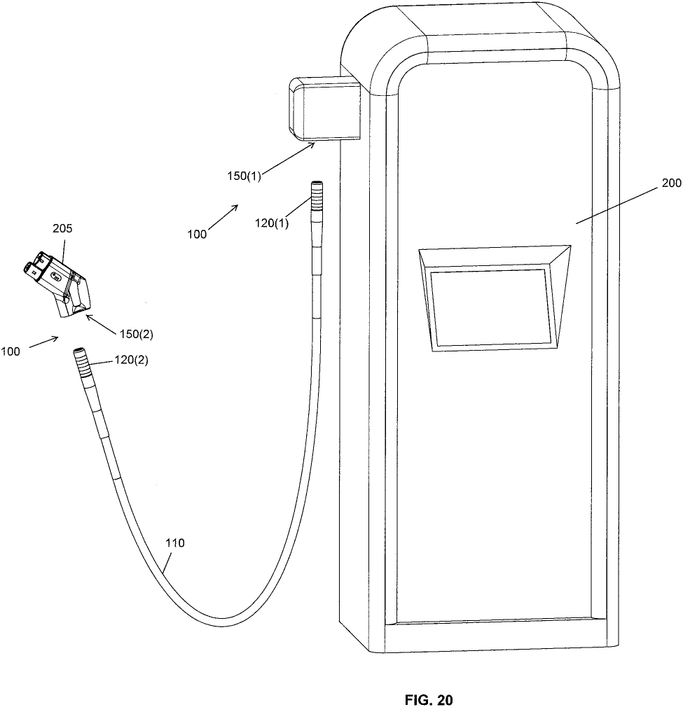

The cable connector assembly 100 has many potential applications, particularly where a cable would be subject to a torque which might twist and turn the cable. One potential application for the turnable or rotatable cable connector assembly 100 described in the present disclosure is illustrated in FIG. 20 to connect an electric vehicle (EV) charging connector 205 to a charging station 200. When a user of the electric vehicle charging station 200 connects the EV charging connector 205 to their electric vehicle (not shown), the EV charging connector 205 is often keyed to the charging port of the electric vehicle requiring the user to turn or rotate the EV charging connector cable 110 to connect the EV charging connector 205 to the charging port of the electric vehicle. The charging connector cable 110 associated with charging station 200 is often bulky, heavy, and relatively inflexible making manipulation of the cable and the connected EV charging connector 205 difficult to handle. In addition, the cable 110 and EV charging connector 205 are subject to wear and torque that damages the cable 110, the EV charging connector 205 and the connection to the charging station 200.

As shown in FIG. 20, one or more pin side connectors 120, preferably two pin side connectors 120(1), 120(2), are electrically connected to cable 110, one pin side connector 120 at each end of cable 110, to alleviate the stress, twisting and damage caused by turning and rotating of the EV charging connector 205 to plug the EV charging connector 205 into the charging port of an electric vehicle. More specifically, the charging station 200 includes a first socket connector 150(1) that receives first pin side connector 120(1) and EV charging connector 205 includes a second socket connector 150(2) that receives second pin side connector 120(2). Cable 110 can freely rotate within both socket connectors 150(1) and 150(2) permitting the user to freely manipulate the EV charging connector 205 to plug into the charging station 200. Being able to freely rotate or turn the EV charging connector 205 without an associated turning or twisting of the cable 110 due to the turnable or rotatable nature of the electrical connector assembly 100 will make manipulating the EV charging connector 205 easier and will result in less wear, tear, and damage to the cable 110, permitting cable 110 to last longer. Moreover, should the cable 110 become damaged, or one of the electrical connector assemblies 100 (e.g., the pins side connector 120 and/or the socket connection 150) become damaged, the damaged part can be easily replaced, including replacing cable 110, or pin side connector 120 on one or both ends of the cable 110. While pin side connector 120 has been shown on both ends of cable 101 it can be appreciated that only one end of cable 110 can include a pin side connector 120 to be received in a respective socket connector 150.

In one or more approaches and configurations a locking mechanism (not shown) can be incorporated or used in electrical connector assembly 100 to resist and/or prevent undesired unmating or disconnection of the pin side connector 120 from the socket connector 150. The locking mechanism can include an internal locking mechanism such as, for example, a ball and detent mechanism as used in a socket wrench, or a metal sleeve which is compressed over the pin side connector 120. Other mechanisms and means to resist or prevent the undesired disconnection of pin side connector 120 from the socket connector 150 of the electrical connector assembly 100 are contemplated and the present disclosure should not be limited to the mechanisms and means described above.

To summarize, a pin side connector for electrically connecting to an electrical socket connector is disclosed, the pin side connector in one or more embodiments including: a plurality of conductor members, each of the plurality of conductor members having a longitudinal axis, a base, and a stem extending from the base along the longitudinal axis of the conductor member, the base having an exterior surface that is substantially circumferentially shaped and the stem configured to electrically connect to one or more conductive wires; and one or more insulator members configured to electrically insulate the plurality of conductor members, at least one of the insulator members having a longitudinal axis, a base portion, and a stem portion extending from the base along the longitudinal axis of the at least one insulator member. In an embodiment of the pin side connector, the longitudinal axis of each of the plurality of conductor members and the longitudinal axis of each of the one or more insulator members is aligned and coincident with a longitudinal axis of the pin side connector. Each base of the plurality of conductor members in a configuration is spaced along the longitudinal axis of the pin side connector and the base portion of the at least one of the one or more insulator members is spaced along the longitudinal axis of the pin side connector, wherein each base of the plurality of conductor members is spaced from and electrically insulated from an adjacent base by the base of the at least one of the one or more insulator members. Each stem of the plurality of conductor members in an arrangement of the pin side connector is aligned with and extends in the direction of the longitudinal axis of the pin side connector and the stem portion of the at least one of the one or more insulator members is aligned with and extends in the direction of the longitudinal axis of the pin side connector. The stem portion of the at least one of the one or more insulator members in a further arrangement of the pin side connector is nested between the stems of adjacent conductor members and electrically insulates the two adjacent conductor members.

The bases of the plurality of conductor members and at least one of the base portions of the one or more insulator members in an embodiment of the pin side connector have a circumferential exterior surface. In a further configuration of the pin side connector, the bases of the plurality of conductor members and the base portions of the one or more insulator members together form a substantially cylindrically shaped or cylindrically shaped exterior surface of alternating conductor members and insulator members along the longitudinal axis of the pin side connector. In a further aspect of the pin side connector, an outer diameter of the bases of the plurality of conductor members and an outer diameter of the base portions of the one or more insulator members are the same. The plurality of conductor members in an embodiment of the pin side connector are rotatably fixed (i.e., are unable to rotate with respect) to the one or more insulator members. The stems of each of the plurality of conductor members of the pin side connector are configured as a hollow tube extending along the longitudinal axis of its respective conductor member and wherein the stem portion of the at least one of the one or more insulator members is configured as a hollow tube extending along the longitudinal axis of the at least one of the one or more insulator members. The hollow tube stem portion of the at least one of the one or more insulator members in a configuration of the pin side connector is concentrically nested between the hollow tube stems of the adjacent conductor members. In a further aspect of the pin side connector, the stem portion of the at least one insulator member is configured as a hollow cylindrical tube and the at least one insulator member has a central channel aligned with the longitudinal axis of the at least one insulator member that is configured and sized to receive a stem of at least one of the plurality of conductor members.

The pin side connector in an embodiment further includes an end cap at its distal end, and in an approach the end cap is in contact with one of the plurality of conductor members. The end cap preferably is rotatably fixed to one of the plurality of conductor members. In a further aspect of the pin side connector, the end cap includes a signal contact cap for connecting to one or more signal wires. An inner most conductor member of the pin side connector has a central channel to receive the one or more signal wires for connecting to the signal contact cap. The signal contact cap according to an embodiment of the pin side connector has one or more exterior facing contact rings configured as concentric rings. The pin side connector in an embodiment includes a cable having the one or more wires wherein the one or more wires are electrically connected to the stems of each of the plurality of conductor members. The one or more wires are electrically connected to the stem of at least one of the plurality of conductor members using a crimp tube. The one or more wires preferably are rotatably fixed to the plurality of conductor members of the pin side connector.

In addition, a socket connector for electrically connecting to a pin side connector is disclosed, the socket connector in one or more embodiments including: a plurality of conductive elements, each conductive element having a center channel aligned along a longitudinal axis of the conductive element; one or more insulative elements, each insulative element having a through-hole aligned along a longitudinal axis of the insulative element; and a housing having a longitudinal axis and an end opening for receiving the pin side connector, the housing retaining the plurality of conductive elements and the one or more insulative elements. Each of the plurality of conductive elements is arranged in an embodiment of the socket connector so that its center channel is aligned with the longitudinal axis of the housing and each of the one or more insulative elements is arranged so it’s through-hole is aligned with the longitudinal axis of the housing. The one or more insulative elements are arranged and configured in an embodiment of the socket connector in alternating relationship between the plurality of conductive elements to electrically insulate the plurality of conductive elements. The center channels of each of the plurality of conductive elements and the through-holes of the one or more insulative elements in an arrangement of the socket connector are aligned and configured to form a receptacle in communication with the end opening. The end opening and the receptacle of the socket connector preferably are configured and shaped to receive the pin side connector.

The socket connector further includes in an embodiment at least one contact spring, and preferably each of the plurality of conductive elements is associated with a contact spring. At least one of the conductive elements in an embodiment of the socket connector has a circumferential channel formed in an inner surface of its center channel, wherein the at least one contact spring is at least partially disposed within the circumferential channel and in an aspect of the socket connector each of the plurality of conductive elements has a circumferential channel formed in an inner surface of its respective center channel, wherein a contact spring is at least partially disposed within each circumferential channel. The socket connector housing in an approach includes a base portion and a retaining cap together retaining and/or containing the plurality of conductive elements and the one or more insulative elements. The retaining cap of the socket connector preferably is snap fit connected to the base portion of the housing, however other means of connecting the base portion and retaining cap are contemplated.

In a further aspect of the socket connector, at least one of the conductive elements comprises a lug portion for receiving an electrical connection, and preferably each of the plurality of conductive elements comprises a lug portion for receiving an electrical connection. In an aspect of the socket connector, the one or more lug portions extend beyond the periphery of the base portion of the housing.

The base portion of the housing in an embodiment includes a central portion and a plurality of legs, the plurality of legs projecting from the central portion. In a further aspect of the socket connector, the plurality of legs are circumferentially spaced around the central portion. One or more slots preferably are located between the plurality of legs, and in a further aspect of the socket connector a plurality of slots are located between the plurality of legs, and the plurality of slots are each of a different length. Each of the plurality of legs in a configuration of the socket connector are spaced circumferentially from an adjacent leg and form slots therebetween to receive a portion of the retaining cap. In an embodiment of the socket connector, at least one leg comprises at least one of a projection or an opening and the retaining cap includes at least one of a respective opening to receive the projection of the leg or a knob to be received in the opening. The retaining cap of the socket connector includes an end portion and one or more projecting portions extending from the end portion. The plurality of projecting portions of the retaining cap of the socket connector preferably are circumferentially spaced around the end portion. In an aspect, a gap is formed between each of the plurality of projecting portions of the retaining cap of the socket connector, and each gap has a different length. In a further embodiment of the socket connector, each of the plurality of projecting portions are spaced circumferentially from an adjacent projecting portion to form gaps therebetween to receive a portion of the base portion.

According to an embodiment of the socket connector, the base portion includes a central portion and a plurality of legs, the plurality of legs projecting from the central portion and the retaining cap includes an end portion and a plurality of projecting portions, the plurality of projecting portion extending from the end portion, wherein each of the plurality of legs are disposed between each of the plurality of projecting portions. In yet a further embodiment of the socket connector, the plurality of legs are circumferentially spaced around the central portion to form a slot between each adjacent leg and each of the slots are of different length and wherein the plurality of projecting portions are circumferentially spaced around the end portion to form a gap between each adjacent projecting portion and each of the gaps are of different length.

An electrical connector assembly is also described that according to one or more embodiments includes: a pin side connector comprising a longitudinal axis, a plurality of conductor members and one or more insulator members configured to electrically insulate the plurality of conductor members, each of the plurality of conductor members having a base and a stem extending from the base and configured to electrically connect to one or more wires, and a socket connector comprising a longitudinal axis, a plurality of conductive elements, one or more insulative elements, and an end opening, wherein each of the plurality of conductive elements has a center channel and is arranged along the longitudinal axis of the socket connector, and wherein each of the one or more insulative elements has a through-hole and is arranged along the longitudinal axis of the socket connector. In a configuration of the electrical connector assembly, each base has a circumferential exterior surface aligned along the longitudinal axis of the pin side connector and each of the one or more insulator members has a base aligned along the longitudinal axis of the pin side connector and configured to alternate between each of the plurality of conductor members and electrically insulate each of the bases of the plurality of conductor members.

In a further configuration of the electrical connector assembly, the center channels of each of the plurality of conductive elements and the through holes of each of the one or more insulative elements are aligned and configured to form a receptacle in communication with the end opening. The end opening and the receptacle in an embodiment of the electrical connector assembly are configured and shaped to receive the pin side connector. The one or more insulative elements in an arrangement are arranged and configured in alternating relationship between the plurality of conductive elements to electrically insulate the plurality of conductive elements. In response to the pin side connector being received within the receptacle of the socket connector, the plurality of conductor members in a configuration of the electrical connector assembly are in electrical contact with the plurality of conductive elements, and in a further aspect the pin side connector is freely rotatable within the receptacle of the socket connector.

The plurality of conductor members and the one or more insulator members together in an arrangement form a substantially cylindrically shaped or a cylindrically shaped exterior surface of alternating conductor members and insulator members along the longitudinal axis of the pin side connector. The plurality of conductor members preferably are rotatably fixed to the one or more insulator members. In an aspect of the electrical connector assembly, the pin side connector further comprises an end cap at its distal end, and the end cap in an embodiment is in contact with one of the plurality of conductor members. The end cap in a further embodiment is rotatably fixed to one of the plurality of conductor members. In an approach, the end cap comprises a signal contact cap for connecting to one or more signal wires. An inner most conductor member in a configuration of the electrical connector assembly has a central channel to receive the one or more signal wires for connecting to the signal contact cap. According to an embodiment of the electrical connector assembly, the signal contact cap has one or more exterior facing contact rings configured as concentric rings.

In an arrangement of the electrical connector assembly, the stem of at least one of the plurality of conductor members is configured as a hollow cylindrical tube. At least one of the one or more insulator members in the electrical connector assembly includes a stem portion extending from its respective base portion, and in an aspect, the stem portion of the at least one insulator member electrically insulates one or more of the stems of one or more of the plurality of conductor members. The stem portion of the at least one insulator member is configured in an embodiment of the electrical connector assembly as a hollow cylindrical tube having an axial bore configured and sized to receive a stem of at least one of the plurality of conductor members. In a further embodiment of the electrical connector assembly, the base of the at least one of the one or more insulator members comprises a central bore aligned with the axial bore of its respective stem portion. The base of each of the one or more insulator members preferably has a circumferential exterior surface. The stem portion of the at least one of the one or more insulator members in an embodiment of the electrical connector assembly concentrically nest with and electrically insulate the stem of one or more of the plurality of conductor members. In a further aspect, at least one of the plurality of conductor members has a stem extending from its respective base as a hollow cylindrical tube and wherein the stem portion of the at least one of the one or more insulator members is configured as a tube, wherein the tube of the stem portion of the at least one of the one or more insulator members concentrically nests with and electrically insulates the hollow cylindrical tube of the stem of at least one of the plurality of conductor members.

The electrical connector assembly according to an embodiment further includes a cable having the one or more wires wherein the one or more wires are electrically connected to the stems of each of the plurality of conductor members. The one or more wires preferably are electrically connected to the stem of at least one of the plurality of conductor members using a crimp tube. In an embodiment of the electrical connector assembly, the cable has one or more wires rotatably fixed to the plurality of conductor members of the pin side connector. The electrical connector assembly according to a further embodiment includes a locking mechanism to lock the pin side connector into the socket connector to resist the pin side connector from being disconnected from the socket connector.

In a further embodiment, the electrical connector assembly includes at least one contact spring, and preferably each of the plurality of conductive elements is associated with a contact spring. In a further aspect of the electrical connector assembly, at least one of the conductive elements has a circumferential channel formed in an inner surface of its center channel, wherein the at least one contact spring is at least partially disposed within the circumferential channel, and preferably each of the plurality of conductive elements has a circumferential channel formed in an interior surface of its respective center channel, wherein a contact spring is at least partially disposed within each circumferential channel.

The socket connector of the electrical connector assembly in an embodiment includes a base portion and a retaining cap together retaining and/or containing the plurality of conductive elements and the one or more insulative elements. The retaining cap preferably is snap fit connected to the base portion of the socket connector. In a further aspect of the electrical connector assembly, at least one of the conductive elements comprises a lug portion for receiving an electrical connection, and preferably each of the plurality of conductive elements comprises a lug portion for receiving an electrical connection. The lug portion in an embodiment extends beyond the periphery of the base portion of the socket connector.

The base portion in an arrangement of the electrical connector assembly includes a central portion and a plurality of legs, the plurality of legs projecting from the central portion. The plurality of legs in a configuration of the electrical connector assembly are circumferentially spaced around the central portion. One or more slots are preferably located and/or provided between the plurality of legs, and in an aspect a plurality of slots are formed, and the plurality of slots are each of a different length. Each of the plurality of legs in an embodiment are spaced circumferentially from an adjacent leg and form slots therebetween to receive a portion of the retaining cap. At least one leg in a configuration of the electrical connector assembly includes at least one of a projection or an opening and the retaining cap comprises at least one of a respective opening to receive the projection of the leg or a knob to be received in the opening.

The retaining cap according to an arrangement of the electrical connector assembly includes an end portion and one or more projecting portions extending from the end portion, and in an aspect, the plurality of projecting portions are circumferentially spaced around the end portion. In a further arrangement, a gap is formed between each of the plurality of projecting portions, where in an aspect each gap is a different length. In a further aspect of the electrical connector assembly, each of the plurality of projecting portions are spaced circumferentially from an adjacent projecting portion to form gaps therebetween to receive a portion of the base portion. Preferably, the base portion of the docket connector includes a central portion and a plurality of legs, the plurality of legs projecting from the central portion and the retaining cap includes an end portion and a plurality of projecting portions, the plurality of projecting portions extending from the end portion, wherein each of the plurality of legs are disposed between each of the plurality of projecting portions. The plurality of legs in an arrangement are circumferentially spaced around the central portion to form a slot between each adjacent leg and each of the slots are of different length and wherein the plurality of projecting portions are circumferentially spaced around the end portion to form a gap between each adjacent projecting portion and each of the gaps are of different length.

An electrical connector assembly according to an embodiment includes a pin side connector and a socket connector, the pin side connector having a plurality of conductor members and one or more insulative members configured to electrically insulate the plurality of conductor members, the conductor members configured to connect to one or more wires; and the socket connector having a plurality of conductive elements and one or more insulative elements arranged to insulate the plurality of conductive elements, wherein each of the plurality of conductive elements having a center channel and each of the one or more insulative elements having a through-hole, wherein the center channels of each of the plurality of conductive elements and each of the through-holes of the one or more insulative elements are arranged and aligned along a longitudinal axis of the socket connector to form a receptacle wherein the pin side connector is receivable in the receptacle and free rotatable with respect to the socket connector.

The corresponding structures, materials, acts, and equivalents of all means or step plus function elements in the claims below are intended to include any structure, material, or act for performing the function in combination with other claimed elements as specifically claimed. The description of the embodiments of the present disclosure has been presented for purposes of illustration and description, but is not intended to be exhaustive or limited to the embodiments in the form disclosed. Many modifications and variations will be apparent to those of ordinary skill in the art without departing from the scope and spirit of the disclosure. The terminology used herein was chosen to best explain the principles of the embodiments, the practical application or technical improvement over technologies found in the marketplace, or to enable others of ordinary skill in the art to understand the embodiments disclosed herein. The embodiments and examples were chosen and described in order to best explain the principles of the disclosure and the practical application, and to enable others of ordinary skill in the art to understand the disclosure for various embodiments with various modifications as are suited to the particular use contemplated.

It will be clear that the various features of the foregoing systems and/or methodologies may be combined in any way, creating a plurality of combinations from the descriptions presented above.

What is claimed is:

1. An electrical connector assembly comprising:
a pin side connector comprising a longitudinal axis, a plurality of conductor members and one or more insulator members configured to electrically insulate the plurality of conductor members, each of the plurality of conductor members having a base and a stem extending from the base and configured to electrically connect to one or more wires,
wherein each base has a circumferential exterior surface aligned along the longitudinal axis of the pin side connector and each of the one or more insulator members has a base aligned along the longitudinal axis of the pin side connector and configured to alternate between each of the plurality of conductor members and electrically insulate each of the bases of the plurality of conductor members; and
a socket connector comprising a longitudinal axis, a plurality of conductive elements, one or more insulative elements, and an end opening, wherein each of the plurality of conductive elements is arranged along the longitudinal axis of the socket connector and has a center channel, and wherein each of the one or more insulative elements is arranged along the longitudinal axis of the socket connector and has a through hole,
wherein the center channels of each of the plurality of conductive elements and the through holes of each of the one or more insulative elements are aligned and configured to form a receptacle in communication with the end opening,
wherein the end opening and the receptacle are configured and shaped to receive the pin side connector, and
wherein the one or more insulative elements are arranged and configured in alternating relationship between the plurality of conductive elements to electrically insulate the plurality of conductive elements,
wherein, in response to the pin side connector being received within the receptacle of the socket connector, the plurality of conductor members are in electrical contact with the plurality of conductive elements, and
wherein the pin side connector is freely rotatable within the receptacle of the socket connector.

2. The electrical connector assembly according to claim 1, wherein the plurality of conductor members and the one or more insulator members together form a cylindrically shaped exterior surface of alternating conductor members and insulator members along the longitudinal axis of the pin side connector.

3. The electrical connector assembly according to claim 1, wherein the pin side connector further comprises an end cap at its distal end in electrical contact with one of the plurality of conductor members, wherein the end cap comprises a signal contact cap for connecting to one or more signal wires, wherein an inner most conductor member has a central channel to receive the one or more signal wires for connecting to the signal contact cap that has one or more exterior facing contact rings configured as concentric rings.

4. The electrical connector assembly according to claim 1, wherein at least one of the one or more insulator members comprises a stem portion extending from its respective base portion as a tube and at least one of the plurality of conductor members comprises a stem extending from its respective base as a hollow cylindrical tube, wherein the tube of the stem portion of the at least one of the one or more insulator members concentrically nests with and electrically insulates the hollow cylindrical tube of the stem of at least one of the plurality of conductor members.

5. The electrical connector assembly according to claim 1, further comprising a cable having the one or more wires wherein the one or more wires are electrically connected to the stems of each of the plurality of conductor members and the one or more wires are rotatably fixed to the plurality of conductor members of the pin side connector.

6. The electrical connector assembly according to claim 1, further comprising a locking mechanism to lock the pin side connector into the socket connector to resist the pin side connector from being disconnected from the socket connector.

7. The electrical connector assembly according to claim 1, further comprising at least one contact spring, wherein at least one of the conductive elements has a circumferential channel formed in an inner surface of its center channel, wherein the at least one contact spring is at least partially disposed within the circumferential channel.

8. The electrical connector assembly according to claim 1, wherein the socket connector comprises a base portion and a retaining cap together retaining the plurality of conductive elements and the one or more insulative elements.

9. The electrical connector assembly according to claim 8, wherein at least one of the conductive elements comprises a lug portion for receiving an electrical connection, wherein the lug portion extends beyond the periphery of the base portion of the socket connector.

10. The electrical connector assembly according to claim 26, wherein the base portion comprises a central portion and a plurality of legs, the plurality of legs projecting from the central portion and circumferentially spaced around the central portion to form a slot between each adjacent leg and each of the projecting legs are of different length, and the retaining cap comprises an end portion and a plurality of projecting portions, the plurality of projecting portion extending from the end portion and circumferentially spaced around the end portion to form a gap between each adjacent projecting portion and each of the projecting portions are of different length, wherein each of the plurality of legs are disposed in the gaps between each adjacent projecting portion and each of the plurality of the projecting portions are disposed in the slots between each adjacent leg.

11. A pin side connector for electrically connecting to an electrical socket connector, the pin side connector comprising:
a plurality of conductor members, each of the plurality of conductor members having a longitudinal axis, a base, and a stem extending from the base along the longitudinal axis of the conductor member, the base having an exterior surface that is substantially circumferentially shaped and the stem configured to electrically connect to one or more conductive wires; and
one or more insulator members configured to electrically insulate the plurality of conductor members, at least one of the insulator members having a longitudinal axis, a base portion, and a stem portion extending from the base along the longitudinal axis of the at least one insulator member,
wherein the longitudinal axis of each of the plurality of conductor members and the longitudinal axis of each of the one or more insulator members is aligned and coincident with a longitudinal axis of the pin side connector;
wherein each base of the plurality of conductor members is spaced along the longitudinal axis of the pin side connector and the base portion of the at least one of the one or more insulator members is spaced along the longitudinal axis of the pin side connector, wherein each base of the plurality of conductor members is spaced from and electrically insulated from an adjacent base by the base of the at least one of the one or more insulator members;
wherein each stem of the plurality of conductor members is aligned with and extends in the direction of the longitudinal axis of the pin side connector and the stem portion of the at least one of the one or more insulator members is aligned with and extends in the direction of the longitudinal axis of the pin side connector, wherein the stem portion of the at least one of the one or more insulator members is nested between the stems of adjacent conductor members and electrically insulates the two adjacent conductor members.

12. The pin side connector according to claim 11, wherein the bases of the plurality of conductor members and the base portions of the one or more insulator members together form a cylindrically shaped exterior surface of alternating conductor members and insulator members along the longitudinal axis of the pin side connector.

13. The pin side connector according to claim 11, wherein the plurality of conductor members are rotatably fixed to the one or more insulator members.

14. The pin side connector according to claim 11, wherein the stems of each of the plurality of conductor members is configured as a hollow tube extending along the longitudinal axis of its respective conductor member and wherein the stem portion of the at least one of the one or more insulator members is configured as a hollow tube extending along the longitudinal axis of the at least one of the one or more insulator members and has a central channel aligned with the longitudinal axis of the at least one insulator member that is configured and sized to receive a stem of at least one of the plurality of conductor members, and wherein the hollow tube stem portion of the at least one of the one or more insulator members is concentrically nested between the hollow tube stems of the adjacent conductor members.

15. The pin side connector according to claim 11, comprising an end cap at its distal end having a signal contact cap for connecting to one or more signal wires, and wherein an inner most conductor member has a central channel to receive the one or more signal wires.

16. A socket connector for electrically connecting to a pin side connector, the socket connector comprising:
a plurality of conductive elements, each conductive element having a center channel aligned along a longitudinal axis of the conductive element;
one or more insulative elements, each insulative element having a through hole aligned along a longitudinal axis of the insulative element; and
a housing having a longitudinal axis and an end opening for receiving the pin side connector, the housing retaining the plurality of conductive elements and the one or more insulative elements,
wherein each of the plurality of conductive elements is arranged so that its center channel is aligned with the longitudinal axis of the housing and each of the one or more insulative elements is arranged so its through hole is aligned with the longitudinal axis of the housing,
wherein the one or more insulative elements are arranged and configured in alternating relationship between the plurality of conductive elements to electrically insulate the plurality of conductive elements,
wherein the center channels of each of the plurality of conductive elements and the through holes of the one or more insulative elements are aligned and configured to form a receptacle in communication with the end opening, and
wherein the end opening and the receptacle are configured and shaped to receive the pin side connector.

17. The socket connector according to claim 16, wherein at least one of the conductive elements has a circumferential channel formed in an inner surface of its center channel, wherein at least one contact spring is at least partially disposed within the circumferential channel.

18. The socket connector according to claim 16, wherein the housing comprises a base portion and a retaining cap together containing the plurality of conductive elements and the one or more insulative elements.

19. The socket connector according to claim 16, wherein at least one of the conductive elements comprises a lug portion for receiving an electrical connection and the lug portion extends beyond a periphery of the base portion of the housing.

20. The socket connector according to claim 16, wherein the base portion of the housing comprises a central portion and a plurality of legs, the plurality of legs projecting from the central portion and circumferentially spaced about the central portion, wherein a plurality of slots are located between the plurality of legs and each of the plurality of slots is a different length and wherein the retaining cap comprises an end portion and one or more projecting portions extending from the end portion and circumferentially spaced around the end portion, wherein a gap is formed between each adjacent projecting portion and each gap is a different length, and wherein each of the plurality of legs are disposed in the gap between each adjacent projecting portion and each of the one or more projecting portions are disposed in one of the plurality of slots located between the plurality of legs.
